(19) United States
(12) Patent Application Publication
(10) Pub. No.: US 2024/0284869 A1
(43) Pub. Date: Aug. 29, 2024

(54) Three Dimensional Shaped Clay Cat Litter

(71) Applicant: Boxiecat LLC, Santa Monica, CA (US)

(72) Inventor: Josh Wiesenfeld, Santa Monica, CA (US)

(73) Assignee: Boxiecat LLC, Santa Monica, CA (US)

(21) Appl. No.: 18/586,454

(22) Filed: Feb. 24, 2024

Related U.S. Application Data
(60) Provisional application No. 63/486,750, filed on Feb. 24, 2023.

(51) Int. Cl. A01K 1/015; B28B 1/00; B33Y 10/00; B33Y 70/00; B33Y 80/00

(52) U.S. Cl. CPC A01K 1/0154; B28B 1/001; B33Y 10/00; B33Y 70/00; B33Y 80/00

(57) ABSTRACT

The present invention is a method of preparing shaped three dimensional clay particles suitable for cat litter with improved absorptivity. The method is three dimensional printing clay slurry in the desired particle shape, and wherein the printed clay particle, when printed at a low temperature and when dried, provides improved absorptivity when compared to extruded clay particles. The particles are not crushed, and the particles are not sintered at elevated temperatures.

### CROSS-REFERENCE TO RELATED APPLICATIONS

This application claims the benefit of provisional patent application No. 63/486,750 filed Feb. 24, 2023, which is hereby incorporated by reference.

### STATEMENT REGARDING FEDERALLY SPONSORED RESEARCH

Not Applicable.

### APPENDIX

Not Applicable.

### BACKGROUND OF THE INVENTION

### Field of the Invention

The present invention relates to cat litter, and more particularly to three dimensional shaped clay cat litter.

### Related Art

Natural clay, also known as earthy clay, has long been used as a liquid absorbent, and has found particular usefulness as an animal litter. Because of the growing number of domestic animals used as house pets, there is a need for litters so that animals may urinate or eliminate liquid or solid waste indoors in a controlled location. Many cat litters use clay as an absorbent. Typically, the clay is mined, dried, and crushed to the desired particle size. While this is a method of controlling the overall size of particles, it does not control the shape of particle. There is a need for shaped clay particles with improved absorptivity.

Extruding clay is a way to provide shaped of litter. Extruded animal litters are known in the art. U.S. Pat. No. 3,923,005 discloses an animal litter comprising alfalfa and starch that is made using an extrusion process. U.S. Pat. No. 4,206,718 discloses a process for producing light weight animal litter from ground alfalfa and gelatinisable flour or starch. In one embodiment, the litters contain up to 10% bentonite as a binder. U.S. Pat. Nos. 5,452,684 and 5,577,463 disclose an animal litter comprising an extruded smectite clay that forms stronger clumps when wetted with animal urine. U.S. Pat. No. 7,603,964 discloses mixing clay materials and a light-weighing material and forming the mixture into a composite particle using various methods such as agglomeration, compaction, and extrusion. WO2009133212A1 discloses methods for producing low-density agglomerated pet litters using minerals with an attapulgite content greater than 50% and an extrusion process.

Generally, these extruded litters perform well for their intended purpose, e.g., absorbing liquid animal waste such as urine. However, there are disadvantages to the extruded clay cat litters. Many of the extruded animal litters, particularly those made from clay and starch, have a “film” on the surface of the litter particles. While this film is useful for various purposes, e.g., reducing the dust created while using the litter, it often adversely affects the absorption rate of the litter. U.S. Pat. No. 8,904,963 discloses extruded animal litter particles that have been fragmented to expose the interior of the particles to the external environment. The interior portion of these extruded litter particles has the ability to absorb liquids such as animal urine or the moisture from animal feces or other wastes at an increased rate compared to the extruded surface portion of the particles. Therefore, extruded animal litters having an increased absorption rate comprise these fragmented animal litter particles, as the inner part of the extruded particle has expanded cells that are more absorptive. Also, the crushed particles have a greater surface to volume ratio which lends itself to more absorptivity. The disadvantage of the crushed extrudates is the increased dust formation of the litter, and the irregular shape of the crushed particles.

Three dimension printing has been used to make porous ceramics, such as specialized filters. However, most three dimension printed objects are sintered (heated to high temperatures) to strengthen the object and create a non-porous surface. The present invention of three dimension printing a porous clay product to use as cat litter has not been suggested. US2017/0251713 discloses a method of three dimension printing an open container and then three dimension printing a foodstuff to go into the container. Clay is mentioned as one of the many possible materials to print as a second material making up the container. Clay is also mentioned as a removable support material. Clay is not mentioned as suitable for absorbing cat urine. US2021/0212352 discloses three dimension printing of containers to fill by three dimension printing with a variety of substances to be delivered. Of the over seventy (70) proposed applications for the three dimension printed delivery systems only one is applied to cat litter. However, there is no mention of natural clay in the printing of the containers, which are printed with polymers that are water soluble or porous. There is no suggestion that the containers are suitable for absorbing cat urine. Quite the contrary, the suggested use of water soluble or porous polymer films, such as polyvinyl alcohol, for the container is totally unsuitable for use as an absorbent cat litter.

The present invention provides shaped absorbent clay particles and methods for making cat litter that do not require crushing. An absorbent material is formed into a particle by a three dimensional (3D) printing process, also called additive manufacturing. While extruded clay litters use starches to bind the extrudate, those form a film on the surface that is less absorptive, as the surface of the extruded clays are heated in the extrusion process. In the present invention, the 3D printing process does not provide a cat litter particle that has such a film, as the 3D process preferably occurs at below 52 degrees C. or alternatively at room temperature. Optionally, the wet print is annealed after printing. Further optionally, performance-enhancing additives are included in the absorbent material during the 3D printing process, homogeneously mixed in and/or in layers. Exemplary additives include antimicrobial agents, odor absorbers/inhibitors, fragrances, health indicating materials, nonstick release agents, and mixtures thereof. Many of the additives are thermolabile and do not withstand heat. The 3D process can provide a method of making the cat litter containing additives, wherein the additives are not damaged by a heating step.

In a preferred embodiment, the absorbent particle does not contain a starch additive. In a more preferred embodiment, the absorbent particle does not have a film on the surface that hinders absorptivity.

In a preferred embodiment, a composite absorbent particle may include a core material wholly or partially enclosed by natural clay.

Favorable characteristics for a litter product such as odor control, additive optimization, low density, low tracking, low dust, strong clamping, etc. can be optimized to give the specific performance required. Another aspect of the invention is the use of encapsulated additives, i.e., formed into the particle itself and accessible via pores or discontinuities in the particles. Encapsulation of additives provides a slow release mechanism such that the additives are effective for a longer period of time. A further aspect of the invention provides control over granule strength, and therefore, degradation and/or disintegration properties. Controlling the rate at which granules degrade, for example when the granules disintegrate due to urine deposition, provides another mechanism to slowly release additives from the granule's interior and surface, and in so doing, optimize performance.

Another advantage of the three dimension printing of cat litter is the ability to control the bulk density of the cat litter to lower the overall weight of the cat litter and increase the convenience for the consumer of lifting and scooping cat litter. Alternatively, if the bulk density is increased, it is less likely that the cat will track litter from the litter box, and it is less likely that the litter will stick to the cat's paws.

Other aspects and advantages of the present invention will become apparent from the following detailed description which illustrates by way of example the principles of the invention.

### SUMMARY OF THE INVENTION

The present invention is a method of preparing shaped three dimensional natural clay particles suitable for cat litter with improved absorptivity. The method is printing a natural clay slurry in the desired particle shape, and wherein the printed natural clay particle, when printed at a low temperature and when dried, provides improved absorptivity when compared to extruded clay particles. The particles are not crushed, and the particles are not sintered at elevated temperatures.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION OF THE PREFERRED EMBODIMENTS

The following description of the preferred embodiment(s) is merely exemplary in nature and is in no way intended to limit the invention, its application, or uses.

The shaped clay cat litter of the present invention is made from natural clay or a mixture of natural clays. The most common natural clays used in cat litters are bentonites, such as sodium bentonite or calcium bentonite that can swell up to 15 times their original volume when exposed to water. Other common clays added to cat litter mixtures are sepiolite, montmorillonite and kaolinite, and combinations thereof. In a preferred embodiment, the clay contains no additives such as gelatinisable flour or starch, or other similar additives that form a skin on the outer surface of the particle.

The shapes suitable for cat litter include, but are not limited to cubes, parallelograms, spheres (both filled and empty), cup shapes, box shapes, open box shapes, and other shapes. Shapes with openings are suitable for increasing absorptivity by increasing surface area. A preferred shape is a parallelogram having right angles and at least two rectangular surfaces.

The size of the litter particles can vary from about 0.065 inch to about 0.50 inch. Preferably, the size is from about 0.20 inch to about 0.40 inch. More preferably, the size is about 0.25 inch to about 0.37 inch. In a preferred embodiment, the particle is a three dimensional polygon.

Preferably, the polygon is approximately rectangular. This shape allows the litter to align when dispensed into a litter box. When compared to shredded (irregularly shaped) pieces of cat litter, the polygon shaped provided better support for the cat's paws when entering the litter box. Preferably, the dimensions of the polygon are less than 0.5 inch. More preferably, they are less than about 0.37 inch. Most preferably the rectangular polygon is from about 0.37 to about 0.10 inch in dimension.

The use of 3D printing, also called additive manufacturing, includes the direct deposition of ceramic materials, called Fused Deposition of Ceramics (FDC), Paste Deposition Modeling (PDM), Extrusion Freeform Fabrication (EFF), Direct Ink Writing (DIW), WASP Liquid Deposition Modeling (LDM). The present invention contemplates all of the above methods, as well as those not listed.

In Front. Mater., 21 Apr. 2021, Sec. Structural Materials, Volume 8-2021 https://doi.org/10.3389/fmats.2021.582885, entitled, “3D-Extrusion Manufacturing of a Kaolinite Dough Taken in Its Pristine State,” Boyer, A. E. et al., Direct Ink Writing (DIW), which is hereby incorporated by reference, is used. This study uses the most popular aluminosilicate material, kaolinite clay with the molecular formula: 2SiO₂·Al₂O₃·2H₂O. Kaolinite is a popular material because it is the most abundant in the earth's crust. DIW, the most common type of 3D printing, builds complex geometric shapes by extruding a material slurry at room temperature, with the ability to print ceramic type slurries that allow them to retain their shape during the extrusion process. Layers of material are printed atop one another in sequence through an extrusion nozzle, where print geometry is created through common computer aided design programs, such as AutoCAD-3D. Once a successful print has been completed by DIW, the specimen must be sintered, a process in which the specimen is heated at very high temperatures to cure the binder used in the slurry to help the material maintain its shape. Binder components used in DIW are typically organic or polymer-based binder fluids.

In a first preferred embodiment, the first step in DIW is making an AutoCAD drawing of the desired shaped article. The drawing is converted to software compatible with the 3D printer. In the second step, the software is loaded onto the printer. For the third step, the clay material is selected, and a slurry is made of the clay and water. The selection for kaolinite clay is in the range of about greater than 23 wt. % and less than 27 wt. % water in the clay/water mixture, although as much as 30 wt. % water has been used with kaolinite. In the fourth step, optimal flow settings are made, and the article is printed at room temperature as a green (wet) article. The fifth and final step is drying and sintering.

The drying and sintering steps typically used for ceramics are initiated after about 24 h of air drying at room temperature.
Step 1: heating ramps 10° C./min for about 48 min from room temperature.
Step 2: annealing at 500° C. (or 700° C.), for about 1 h causing the following reaction: Al₂(OH)₄Si₂O→Al₂O₃ 2SiO₂+2H₂O (hydrated kaolin) (metakaolin) (water, eliminated).
Step 3: heating ramps 10° C./min 350-750° C. causing the following reaction: Al₂O₃2SiO₂→Al₂O₃+SiO₂ (metakaolin) (alumina) (silica) 950-1050° C., Al₂O₃2SiO₂→MgAl₂O₄+SiO₂ (metakaolin) (spinel) (amorphous silica).
Step 4: sintering 1200° C., 1 h causing the following reaction: Al₂O₃2SiO₂→2(3Al₂O₃ 2SiO₂)+5SiO₂ (metakaolin) (mullite) (amorphous silica).
Step 5: cooling ramp 10° C./min.

The present invention is the preparation of absorbent cat litter. To that end, the drying and sintering process would not be carried to completion, as sintering removes porosity and densifies the material. The method of preparing absorbent cat litter would be completed at the end of the annealing step where the evaporating water has created open-cell pores. The clay article at that point has eliminated molecular water, and is porous. The preferred annealing temperature range is from about 200 to 1000° C. A more preferred annealing temperature range is from about 250 to 750° C. Heating above 1000° C., and more particularly, up to 1200° C., is avoided.

In a second preferred embodiment, the printed litter can be completed by drying at low temperatures (below 52 degrees C.) or room temperature. This process is most effectively used with “quick drying” clays. One quick drying clay is paperclay. Paperclay is a natural clay combined with fibers. Natural fibers are cellulosic fibers such as provided by paper pulp, cotton, hemp, flax, linen and wood. The advantages of paperclay are that the products are light weight and fast drying. Typically, paperclay comprises from 1 to 25 wt. % cellulosic fibers. More preferably, the clay comprises from 2 to 20 wt. % cellulosic fibers. When recycled materials, such as newsprint or cardboard are used, the cat litter has the preferred characteristic of reusing recycled materials. In a preferred embodiment, paperclay is combined with natural clay to form the cat litter particles.

Another preferred quick drying epoxy clay. Epoxy clay is clay combined with the two parts of the epoxy adhesive, separated. When separated, the two parts of the epoxy clay are stable for storage. When the clay is to be used, the two parts are combined, preferably equally, and the combined clay hardens in about 4 to 24 hours at room temperature. Commercially available epoxy clays include Apoxie® Sculpt, Magic™ Sculpt, and Milliput™ Putty.

The absorbent cat litter of the present invention absorbs at least 50 wt. % of its weight in water. Preferably, the absorbent cat litter absorbs from 50 wt. % to 200 wt. % of its weight in water. Most preferably, the absorbent cat litter absorbs from 100 wt. % to 200 wt. % of its weight in water.

In a preferred embodiment, the clay is combined with additional components such as silica, ceramic powder, wood ash, etc. Kaolinite has been mixed with lime, talc and fly ash at concentrations of 3 wt. %, 5 wt. %, and 7 wt. % with varied results. The addition of steel dust waste from the electric arc furnace (EAFD) was studied and an optimal amount of 20% was determined. A study was made of adding hydroxyapatite to clay and it was determined that the weight ratio of clay to hydroxyapatite was 80:20 wt. % showed better print quality. It has also been reported that adding waste ceramic dust to clay improves strength and water absorption.

Additives are used to improve kaolinite flow properties, such as sodium silicate and sodium polyacrylate at concentrations ranging from 0.2 to 0.8 wt. %.

The three dimension printed cat litter can be combined with other types of litter, including extruded clay litter, crushed clay litter, cellulosic litter, etc. However, the preferred combination contains from about 1 to 100 wt. % three dimension printed litter. In a more preferred combination the amount of three dimension printed litter is at less than 50 wt. %. In another embodiment of the invention the combination contains the three dimension printed litter at less than 10 wt. %. In another embodiment of the invention, the combination contains from about 1 to 10 wt. % three dimension printed litter.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A process of making a shaped cat litter particle comprising three dimensional printing to make the particle,
wherein the particle comprises natural clay;
wherein the particle is not extruded;
wherein the particle is absorbent; and
wherein the three dimensional printed particles are not crushed.

2. The process of claim 1, wherein the three dimensional printing process is selected from the group consisting of Fused Deposition of Ceramics, Paste Deposition Modeling, Extrusion Freeform Fabrication, Direct Ink Writing, and Liquid Deposition Modeling.

3. The process of claim 2, wherein the cat litter absorbs from 50 to 200 wt. % of its weight in water.

4. The process of claim 3, wherein the process further comprises Direct Ink Writing, wherein the process further comprises the steps:
forming a natural clay slurry from the clay;
three dimensional printing a wet shaped particle; and
drying the wet shaped particle to form the shaped cat litter particle.

5. The process of claim 4, wherein the wet shaped article is dried by annealing at from about 200 degrees C. to 1000 degrees C.

6. The process of claim 1, wherein the particle does not contain starch.

7. The process of claim 6, wherein the particle does not have a starch film on its surface that hinders absorption.

8. The process of claim 4, wherein the wet shaped particle is air dried at below 52 degrees C.

9. The process of claim 8, wherein the natural clay is selected from the group consisting of paperclay and epoxy clay.

10. A particle for cat litter made by the process comprising three dimensional printing to make the particle,
wherein the particle comprises natural clay;
wherein the particle is not extruded;
wherein the particle is absorbent;
wherein the three dimensional printed particle is not crushed; and
wherein the particle has a three dimensional shape.

11. The of claim 10, wherein the three dimensional printing process is selected from the group consisting of Fused Deposition of Ceramics, Paste Deposition Modeling, Extrusion Freeform Fabrication, Direct Ink Writing, and Liquid Deposition Modeling.

12. The particle of claim 11, wherein the particle absorbs from 50 to 200 wt. % of its weight in water.

13. The particle of claim 12, wherein the particle further comprises Liquid Deposition Modeling, wherein the process further comprises the steps:
forming a natural clay slurry from the clay;
three dimensional printing a wet shaped particle; and
drying the wet shaped particle to form the shaped cat litter particle.

14. The particle of claim 13, wherein the wet shaped article is dried by annealing at from about 200 degrees C. to 1000 degrees C.

15. The particle of claim 10, wherein the particle does not contain starch.

16. The particle of claim 15, wherein the particle does not have a starch film on its surface that hinders absorption.

17. The particle of claim 13, wherein the wet shaped particle is air dried at below 52 degrees C.

18. The particle of claim 8, wherein the natural clay is selected from the group consisting of paperclay and epoxy clay.

19. The particle of claim 1, wherein the three dimensional shape is selected from the group consisting of cubes, parallelograms, spheres, either filled or empty, cup shapes, closed box shapes, and open box shapes.

20. The particle of claim 19, wherein the three dimensional shape is selected from the group consisting of parallelograms, wherein the parallelograms have right angles and at least two rectangular surfaces.
